(19) United States
(12) Patent Application Publication
(10) Pub. No.: US 2021/0122591 A1
(43) Pub. Date: Apr. 29, 2021

(54) DISPENSABLE STACK OF SHEETS

(71) Applicant: 3M INNOVATIVE PROPERTIES COMPANY, SAINT PAUL, MN (US)

(72) Inventors: AUDREY A. SHERMAN, WOODBURY, MN (US); AMANDA C. ENGLER, WOODBURY, MN (US); MICHAEL J. TURNBULL, WOODBURY, MN (US)

(73) Assignee: 3M INNOVATIVE PROPERTIES COMPANY, SAINT PAUL, MN (US)

(21) Appl. No.: 17/067,842

(22) Filed: Oct. 12, 2020

Related U.S. Application Data
(60) Provisional application No. 62/926,687, filed on Oct. 28, 2019.

(51) Int. Cl. B65H 1/04; B32B 7/12; B32B 7/06; B32B 43/00

(52) U.S. Cl. CPC B65H 1/04; B32B 7/12; B32B 2405/00; B32B 43/006; B32B 7/06

(57) ABSTRACT

The disclosed stack carries individual sheets arranged one on top of the other for individual removal of each successive sheet from the stack. Holding the stack together are individual substrates with an adhesive portion. The adhesive portion on a substrate partially secures to a sheet and partially secures to an underlying substrate on alternating ends of the stack. Therefore, the free end of the sheet can be easily pulled free from the stack, exposing a free end of the next underlying sheet to be easily pulled free from the stack.

### CROSS-REFERENCE TO RELATED APPLICATION

This application claims the benefit of priority to U.S. Provisional Application No. 62/926,687, filed on Oct. 28, 2019, which is incorporated herein by reference in its entirety.

### TECHNICAL FIELD

The present disclosure relates to a dispensable stack of sheets.

### BACKGROUND

Adhesive tape is commonly used for many applications. Typically, an elongated tape is wrapped around a core into a roll. To use the tape, the elongated tape is pulled from the roll and cut or torn for a usable section, which typically requires two hands. Precut tape strips can be used. Precut tape strips in various shapes can be secured to a release liner and then peeled from the release liner for use. Individual sheets of precut tape strips on liners are not easily organized or quickly dispensed for use.

### SUMMARY

The disclosed stack carries individual sheets arranged one on top of the other for individual removal of each successive sheet from the stack. Holding the stack together are individual substrates with an adhesive portion. The adhesive portion on a substrate partially secures to a sheet and partially secures to an underlying substrate on alternating ends of the stack. Therefore, a free end of the sheet can be easily pulled free from the stack, exposing a free end of the next underlying sheet to be easily pulled free from the stack.

In one embodiment, a stack of sheets with a first end and a second end, opposite the first end, includes a first delivery portion and a second delivery portion. The first delivery portion includes a substrate having a first major surface and a second major surface, opposite the first major surface. The first delivery portion further includes an adhesive disposed on a portion of the second major surface of the substrate of the first delivery portion at the first end of the stack, and a sheet removably secured to a portion of the adhesive disposed on the substrate of the first delivery portion. The second delivery portion includes a substrate having a first major surface and a second major surface, opposite the first major surface. The second delivery portion further includes an adhesive disposed on a portion of the second major surface of the substrate of the second delivery portion at the second end of the stack, and a sheet removably secured to a portion of the adhesive disposed on the substrate of the second delivery portion. The adhesive of the first delivery portion removably secures to the first major surface of the substrate of the second delivery portion at the first end of the stack.

In one embodiment, the stack of sheets further includes a third delivery portion including a substrate having a first major surface and a second major surface, opposite the first major surface. The third delivery portion further includes an adhesive disposed on a portion of the second major surface of the substrate of the third delivery portion at the first end of the stack, and a sheet removably secured to a portion of the adhesive disposed on the substrate of the third delivery portion. The adhesive of the second delivery portion removably secures to the first major surface of the substrate of the third delivery portion at the second end of the stack.

In one embodiment, the sheet of at least one of the first, second and third delivery portions includes a free end that is disconnected from the stack and forms a flag.

In one embodiment, the free end of the sheet of the at least one of the first, second and third delivery portions extends beyond an edge of the corresponding substrate.

In one embodiment, the sheet of each of the first, second and third delivery portions is not secured to a first major surface of an underlying substrate.

In one embodiment, the sheet of at least one of the first, second and third delivery portions includes a sheet adhesive on a top surface of the sheet. The sheet adhesive releasably secures the sheet to a non-adhesive portion of the second major surface of the corresponding substrate.

In one embodiment, the sheet adhesive is a pressure sensitive adhesive.

In one embodiment, the sheet of each of the first, second and third delivery portions carries at least one object.

In one embodiment, the at least one object is a tape strip.

In one embodiment, the adhesive of each of the first, second and third delivery portions is a pressure sensitive adhesive.

In one embodiment, a dispenser includes an opening and receives the stack of sheets. The sheet of the first delivery portion extends at least partly through the opening.

In one embodiment, a dispensing system includes a dispenser including an opening. The dispensing system further includes a stack of sheets with a first end and a second end, opposite the first end. The stack of sheets includes a first delivery portion and a second delivery portion. The first delivery portion includes a substrate having a first major surface and a second major surface, opposite the first major surface. The first delivery portion further includes an adhesive disposed on a portion of the second major surface of the substrate of the first delivery portion at the first end of the stack, and a sheet removably secured to a portion of the adhesive disposed on the substrate of the first delivery portion. The second delivery portion includes a substrate having a first major surface and a second major surface, opposite the first major surface. The second delivery portion further includes an adhesive disposed on a portion of the second major surface of the substrate of the second delivery portion at the second end of the stack, and a sheet removably secured to a portion of the adhesive disposed on the substrate of the second delivery portion. The adhesive of the first delivery portion removably secures to the first major surface of the substrate of the second delivery portion at the first end of the stack. The sheet of the first delivery portion extends at least partly through the opening of the dispenser.

In one embodiment, a method of dispensing the stack of sheets of the dispensing system includes providing the stack of sheets in the dispenser. The method further includes extending the sheet of the first delivery portion at least partly through the opening of the dispenser. The method further includes pulling the sheet of the first delivery portion to at least partially extend the sheet of the second delivery portion through the opening. The method further includes detaching the substrate of the first delivery portion from the substrate of the second delivery portion.

### BRIEF DESCRIPTION OF DRAWINGS

FIG. 1 is a side sectional view of one embodiment of a stack of delivery portions carrying sheets;

FIG. 2 is a bottom view of a first delivery portion of FIG. 1 including a sheet with objects and a corresponding substrate removably secured to the sheet;

FIG. 3 is a side sectional view of one embodiment of a dispensing system including a dispenser and the stack of FIG. 1;

FIG. 4 is a flowchart of a method of dispensing the delivery portions of the stack of FIG. 1;

FIGS. 5 and 6 illustrate dispensing of the first delivery portion from the dispenser of FIG. 3; and

FIG. 7 is a side sectional view of another embodiment of a stack of delivery portions carrying sheets.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

A conventional adhesive tape is generally wrapped around a core into a roll. To use the tape, an elongated tape is pulled from the roll and cut or torn for a usable section, which typically requires two hands. Such a roll of tape may have to be manually cut by a cutting member. It is difficult for a user to manually cut precise, uniform lengths of the adhesive tape from the roll as it is difficult to repeatedly measure the lengths precisely. Such a tape/dispenser combination is not suitable for situations which require quick and efficient dispensing of precisely uniform, pre-cut lengths of adhesive coated tape. Further, a form factor offered by a roll of tape on a core may create problems for the end users in a handheld setting. A roll of tape may be difficult to package, ship and fit into kits.

Precut tape strips can be used. Precut tape strips in various shapes can be secured to a release liner and then peeled from the release liner for use. However, individual sheets of precut tape strips on liners are not easily organized or quickly dispensed for use.

A stack of sheets according to the present disclosure includes a plurality of delivery portions stacked on top of each other. Each delivery portion includes a substrate and a sheet. The substrate includes an adhesive portion. The adhesive portion on the substrate partially secures to the sheet and partially secures to an underlying substrate. Successive substrates are connected to each other at alternating ends of the stack. The sheet includes a free end. The free end of the sheet can be easily pulled free from the stack, exposing a free end of the next underlying sheet to be easily pulled free from the stack.

The present disclosure also relates to a dispensing system including a dispenser and the stack of sheets. The dispenser includes a cavity for receiving the stack and an opening for sequential dispensing of the delivery portions. The free end of the sheet of an uppermost delivery portion extends through the opening, thereby enabling one-handed dispensing.

The stack and the dispensing system of the present disclosure may enable one-handed dispensing. The stack may further enable compact and flat packaging as opposed to conventional tape rolls. Compact packaging may facilitate shipping and supply. The stack and the dispensing system can easily fit into kits. Further, the dispensing system can be easily placed at a point of use or care. The stack may also allow the delivery portions to be organized efficiently. In some cases, the substrate of each delivery portion can also be used as an instruction sheet.

As used herein, the term “stack” refers to a stack of sheets.

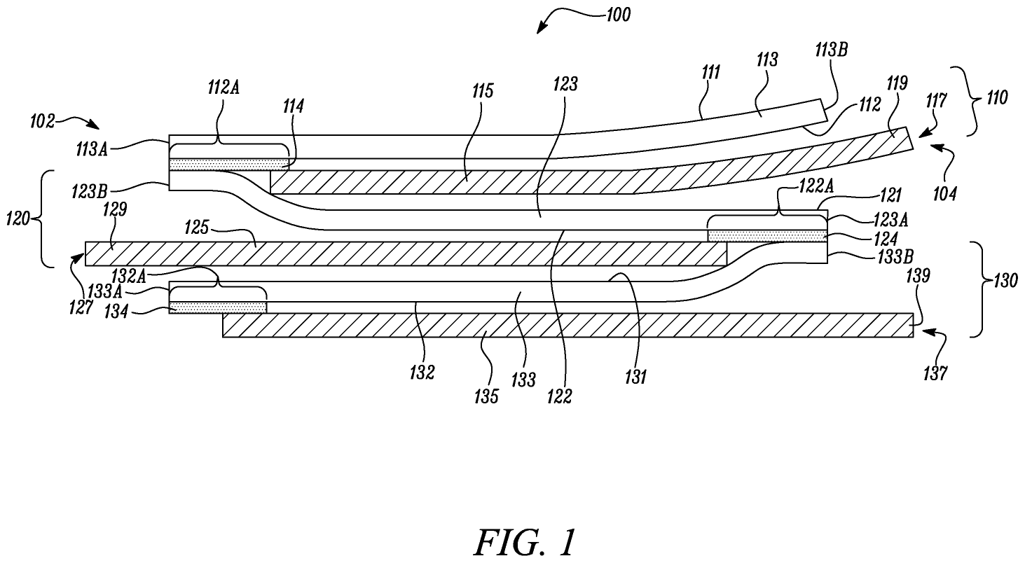

FIG. 1 illustrates a side sectional view of one embodiment of a stack of sheets 100 (hereinafter referred to as “stack 100”). The stack 100 includes a first end 102 and a second end 104, opposite the first end 102. The stack 100 further includes a first delivery portion 110, a second delivery portion 120, and a third delivery portion 130 stacked on top of each other. Three sequentially stacked delivery portions 110, 120, 130 are shown in FIG. 1 for the purposes of clarity. However, the stack 100 may include any number of delivery portions within the scope of the present disclosure.

The first delivery portion 110 includes a substrate 113 having a first major surface 111 and a second major surface 112, opposite the first major surface 111. The first delivery portion 110 further includes an adhesive 114 disposed on a portion 112A of the second major surface 112 of the substrate 113 of the first delivery portion 110 at the first end 102 of the stack 100. The substrate 113 includes a first edge 113A proximate the first end 102 of the stack 100 and a second edge 113B, opposite the first edge 113A. The first and second edges 113A, 113B may be transverse edges of the substrate 113. The adhesive 114 extends from the first edge 113A of the substrate 113 and covers the portion 112A of the second major surface 112 of the substrate 113. In some embodiments, the adhesive 114 covers less than 50%, less than 30%, less than 20%, or less than 10% of an area of the second major surface 112 of the substrate 113. In some embodiments, the adhesive 114 may be uniformly disposed on the portion 112A of the second major surface 112 of the substrate 113. In alternative embodiments, the adhesive 114 may be non-uniformly disposed on the portion 112A of the second major surface 112 of the substrate 113.

The first delivery portion 110 further includes a sheet 115 removably secured to a portion of the adhesive 114 disposed on the substrate 113 of the first delivery portion 110. The portion of the adhesive 114 that is removably connected to the sheet 115 is spaced apart from the first edge 113A of the substrate 113.

The second delivery portion 120 includes a substrate 123 having a first major surface 121 and a second major surface 122, opposite the first major surface 121. The second delivery portion 120 further includes an adhesive 124 disposed on a portion 122A of the second major surface 122 of the substrate 123 of the second delivery portion 120 at the second end 104 of the stack 100. The substrate 123 includes a first edge 123A proximate the second end 104 of the stack 100 and a second edge 123B, opposite the first edge 123A. The first and second edges 123A, 123B may be transverse edges of the substrate 123. The adhesive 124 extends from the first edge 123A of the substrate 123 and covers the portion 122A of the second major surface 122 of the substrate 123. In some embodiments, the adhesive 124 covers less than 50%, less than 30%, less than 20%, or less than 10% of an area of the second major surface 122 of the substrate 123. In some embodiments, the adhesive 124 may be uniformly disposed on the portion 122A of the second major surface 122 of the substrate 123. In alternative embodiments, the adhesive 124 may be non-uniformly disposed on the portion 122A of the second major surface 122 of the substrate 123.

The second delivery portion 120 further includes a sheet 125 removably secured to a portion of the adhesive 124 disposed on the substrate 123 of the second delivery portion 120. The portion of the adhesive 124 that is removably connected to the sheet 125 is spaced apart from the first edge 123A of the substrate 123.

The adhesive 114 of the first delivery portion 110 removably secures to the first major surface 121 of the substrate 123 of the second delivery portion 120 at the first end 102 of the stack 100. A portion of the adhesive 114 extending from the first edge 113A of the substrate 113 and not secured to the sheet 115 of the first delivery portion 110 is removably secured to the first major surface 121 of the substrate 123 of the second delivery portion 120. The portion of the adhesive 114 that is removably secured to the sheet 115 and the portion of the adhesive 114 that is removably secured to the substrate 123 may have same or different areas. In some cases, a portion of the adhesive 114 may remain unsecured to both the sheet 115 and the substrate 123.

The third delivery portion 130 includes a substrate 133 having a first major surface 131 and a second major surface 132, opposite the first major surface 131. The third delivery portion 130 further includes an adhesive 134 disposed on a portion 132A of the second major surface 132 of the substrate 133 of the third delivery portion 130 at the first end 102 of the stack 100. The substrate 133 includes a first edge 133A proximate the first end 102 of the stack 100 and a second edge 133B, opposite the first edge 133A. The first and second edges 133A, 133B may be transverse edges of the substrate 133. The adhesive 134 extends from the first edge 133A of the substrate 133 and covers the portion 132A of the second major surface 132 of the substrate 133. In some embodiments, the adhesive 134 covers less than 50%, less than 30%, less than 20%, or less than 10% of an area of the second major surface 132 of the substrate 133. In some embodiments, the adhesive 134 may be uniformly disposed on the portion 132A of the second major surface 132 of the substrate 133. In alternative embodiments, the adhesive 134 may be non-uniformly disposed on the portion 132A of the second major surface 132 of the substrate 133. In some embodiments, the adhesive 114, 124, 134 of each of the first, second and third delivery portions 110, 120, 130 is a pressure sensitive adhesive.

The third delivery portion 130 further includes a sheet 135 removably secured to a portion of the adhesive 134 disposed on the substrate 133 of the third delivery portion 130. The portion of the adhesive 134 that is removably connected to the sheet 135 is spaced apart from the first edge 133A of the substrate 133. Another portion of the adhesive 134 may be removably secured to a first major surface of an underlying substrate (not shown).

The adhesive 124 of the second delivery portion 120 removably secures to the first major surface 131 of the substrate 133 of the third delivery portion 130 at the second end 104 of the stack 100. A portion of the adhesive 124 extending from the first edge 123A of the substrate 123 and not secured to the sheet 125 of the second delivery portion 120 is removably secured to the first major surface 131 of the substrate 133 of the third delivery portion 130. The portion of the adhesive 124 that is removably secured to the sheet 125 and the portion of the adhesive 124 that is removably secured to the substrate 133 may have same or different areas. In some cases, a portion of the adhesive 124 may remain unsecured to both the sheet 125 and the substrate 133.

The adhesive 114 of the first delivery portion 110 is disposed at the first end 102 of the stack 100. Therefore, the first delivery portion 110 is removably secured to the second delivery portion 120 at the first end 102 of the stack 100. The adhesive 124 of the second delivery portion 120 is disposed at the second end 104 of the stack 100. Therefore, the second delivery portion 120 is removably secured to the third delivery portion 130 at the second end 104 of the stack 100. The adhesive 134 of the third delivery portion 130 is at the first end 102 of the stack 100. Therefore, the third delivery portion 130 is removably secured to an underlying delivery portion (not shown) at the first end 102. In general, an adhesive end of each delivery portion alternates with an adhesive end of an underlying or overlying delivery portion. The stack 100 may therefore be a Z-stack of delivery portions. A Z-folded or fan-folded configuration of the stack 100 may facilitate dispensing of successive delivery portions from a dispenser (not shown in FIG. 1).

In some embodiments, the sheet 115, 125, 135 of each of the first, second and third delivery portions 110, 120, 130 is not secured to the first major surface of the underlying substrate. Specifically, the sheet 115 of the first delivery portion 110 is not secured to the first major surface 111 of the underlying substrate 123 of the second delivery portion 120. Similarly, the sheet 125 of the second delivery portion 120 is not secured to the first major surface 121 of the underlying substrate 133 of the third delivery portion 130. The sheet 135 of the third delivery portion 130 is not secured to the first major surface of the underlying substrate (not shown).

In some embodiments, the sheet of at least one of the first, second and third delivery portions 110, 120, 130 includes a free end that is disconnected from the stack 100 and forms a flag. The free end of the sheet of the at least one of the first, second and third delivery portions 110, 120, 130 extends beyond the second edge 113B, 123B, 133B of the corresponding substrate 113, 123, 133. In the illustrated embodiment of FIG. 1, the sheet 115 of the first delivery portion 110 includes a free end 117 that is disconnected from the stack 100 and forms a flag 119. The flag 119 is disposed at the first end 102 of the stack 100. Further, the flag 119 extends beyond the second edge 113B of the substrate 113 of the first delivery portion 110. The sheet 125 of the second delivery portion 120 includes a free end 127 that is disconnected from the stack 100 and forms a flag 129. The flag 129 is disposed at the second end 104 of the stack 100. Further, the flag 129 extends beyond the second edge 123B of the substrate 123 of the second delivery portion 120. The sheet 135 of the third delivery portion 130 includes a free end 137 that is disconnected from the stack 100 and forms a flag 139. The flag 139 is disposed at the first end 102 of the stack 100. Further, the flag 139 extends beyond the second edge 133B of the substrate 133 of the third delivery portion 130. In some embodiments, a length of each of the flags 119, 129, 139 is at least 5%, at least 10%, at least 15%, at least 20%, or at least 25% of a total length of the respective sheet 115, 125, 135. The flags 119, 129, 139 may enable one-handed dispensing of the respective first, second and third delivery portions 110, 120, 130 from the stack 100.

In some embodiments, the stack 100 is received within a dispenser (not shown in FIG. 1). The dispenser includes an opening for dispensing of the first, second and third delivery portions 110, 120, 130. The sheet 115 of the first delivery portion 110 extends at least partly through the opening of the dispenser. The substrate 113 of the first delivery portion 110 may also extend at least partly through the opening. The first delivery portion 110 can be dispensed by one hand by pulling the sheet 115. Upon pulling the sheet 115 of the first delivery portion 110, the second delivery portion 120 at least partly extends from the opening due to the removable connection between the substrate 113 of the first delivery portion 110 and the substrate 123 of the second delivery portion 120. The second delivery portion 120 can extend at least partly through the opening upon pulling of the sheet 115 due to the fan-folded configuration of the stack 100. Specifically, the removable adhesive connection between the second delivery portion 120 and the third delivery portion 130 is at an opposite end relative to the removable adhesive connection between the first delivery portion 110 and the second delivery portion 120. Therefore, the second delivery portion 120 can move along with the first delivery portion 110 without substantially impacting the removable adhesive connection with the third delivery portion 130.

The substrate 113 of the first delivery portion 110 can be then detached from the substrate 123 of the second delivery portion 120 by further pulling. The sheet 125 of the second delivery portion 120 may then extend at least partly through the opening of the dispenser. The second delivery portion 120 can be dispensed by one hand in a similar manner as the first delivery portion 110. In general, a sheet of an uppermost delivery portion of the stack 100 extends at least partly from the opening of the dispenser. Upon pulling the sheet of the uppermost delivery portion by one hand, the sheet of the underlying delivery portion also extends at least partially through the opening. The substrate of the uppermost delivery portion can be detached from the substrate of the underlying delivery portion by further pulling.

Each of the first, second and third delivery portions 110, 120, 130 may be used to deliver one or more objects (not shown in FIG. 1). In some embodiments, each of the first, second and third delivery portions 110, 120, 130 carries at least one object.

In some embodiments, the sheet 115, 125, 135 of at least one of the first, second and third delivery portions 110, 120, 130 includes a sheet adhesive (not shown in FIG. 1) on a top surface of the sheet. The sheet adhesive releasably secures the sheet to a non-adhesive portion of the second major surface of the corresponding substrate.

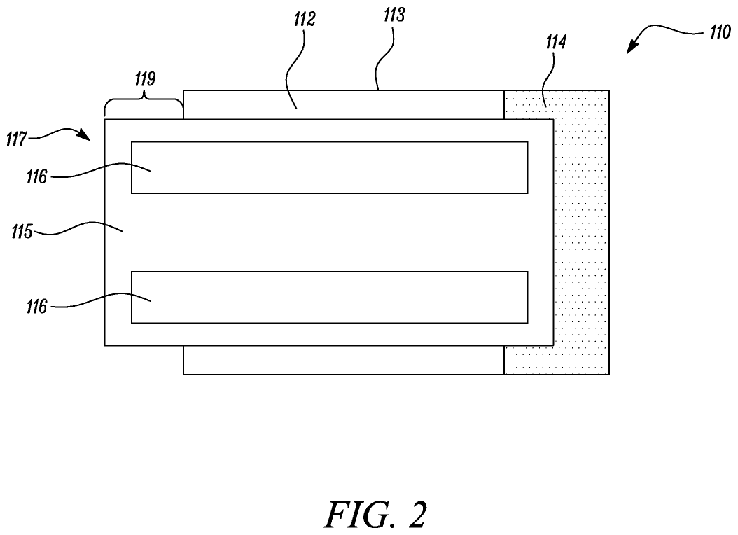

FIG. 2 is a bottom view of the first delivery portion 110. In the illustrated embodiments of FIG. 2, each of the substrate 113 and the sheet 115 is substantially rectangular. However, each of the substrate 113 and the sheet 115 may have alternative shapes, such as circular, square, polygonal, elliptical, oval, and so forth. In some embodiments, a width of the sheet 115 may be less than a width of the substrate 113. In some other embodiments, the width of the sheet 115 may be greater than or equal to the width of the substrate 113. The sheet 115 is releasably secured to the portion of the adhesive 114. At least a portion of the remaining adhesive 114 is releasably secured to the substrate 123 of the second delivery portion 120 (shown in FIG. 1). In some embodiments, a length of the sheet 115 may be greater than a length of the substrate 113. In some other embodiments, the length of the sheet 115 may be less than or equal to the length of the substrate 113. In some embodiments, a thickness of the sheet 115 may be greater than a thickness of the substrate 113. In some other embodiments, the thickness of the sheet 115 may be less than or equal to the thickness of the substrate 113.

The sheet 115 of the first delivery portion 110 carries at least one object 116. In some embodiments, the at least one object 116 is a tape strip. In the illustrated embodiment of FIG. 2, the sheet 115 carries two objects 116. However, the sheet 115 can carry any number of the objects 116. Each object 116 has a substantially rectangular shape. However, a shape of each object 116 may vary as per the application. For example, the object 116 may have a circular shape, a polygonal shape, an oval shape, an irregular shape, and so forth. The objects 116 are preferably flat adhesive products of various shapes and sizes, for example, pre-cut adhesive tape strips, medical tapes, medical dressings, etc. In some cases, each object 116 may be a non-sterile medical dressing removably secured to the sheet 115.

The sheet 115 may act as a liner for the objects 116. The objects 116 can be peeled from the sheet 115 during use. The objects 116 are shown to be disposed on a surface of the sheet 115 opposite to the substrate 113. However, the objects 116 may alternatively or additionally be disposed on a surface of the sheet 115 facing the substrate 113.

The first delivery portion 110 is shown in FIG. 2 for illustration purposes. It may be contemplated that each of the second and third delivery portions 120, 130 may have a configuration that is substantially similar to that of the first delivery portion 110. The first delivery portion 110 may be used to dispense the sheet 115 including the objects 116. Similarly, the sheets 125, 135 of the second and third delivery portions 120, 130, respectively, carries at least one object (not shown), such as tape strips. In some embodiments, the substrate 113, 123, 133 of each of the first, second and third delivery portions 110, 120, 130 is an instruction sheet related to use of the corresponding objects.

Individual components of each of the first, second and third delivery portions 110, 120, 130 may include different materials/configurations. Some exemplary materials/configurations are provided below.

Substrate

Each of the substrates 113, 123, 133 may include substantially any flat, flexible material having the necessary structural integrity. Suitable materials include (i) polymeric films of brightened acetate, unbrightened acetate, thermosets, thermoplastics such as polyester, polypropylene, and vinyl polymers, (ii) paper, and (iii) metal foil. Various laminated combinations of such materials may also be used.

Adhesive

Each of the adhesives 114, 124, 134 may be any of a variety of removable/repositionable adhesives, preferably, of pressure sensitive type. Any of the known pressure sensitive adhesives, including, but not limiting to, acrylic, silicone, silicone-acrylate hybrid, silicone block co-polymers, rubber-resin pressure sensitive adhesives, natural rubber, and low peel pressure sensitive adhesives containing tacky elastomeric copolymer microspheres may be used. In some applications, the adhesive can be suitable for securing to skin. The adhesives can be a continuous coating, a pattern coating, or microstructured.

Sheets

Each of the sheets 115, 125, 135 may be suitable for use in construction of adhesive tape sheets and include substantially any flat, flexible material having the necessary structural integrity. Suitable materials include (i) polymeric films of brightened acetate, unbrightened acetate, thermosets, thermoplastics such as polyester, polypropylene, and vinyl polymers, (ii) paper, and (iii) metal foil. Various laminated combinations of such materials may also be used.

In some embodiments, each of the sheets 115, 125, 135 may include a release material. This may allow the objects 116 to be removably secured to the corresponding sheets 115, 125, 135. The release material (e.g., a silicone) is typically coated on the surface of the release side. Suitable release materials include, but are not limited to, low surface energy materials such as silicones, epoxy silicones cured by photo-acid generated crosslinking, fluorosilicones, silicone acrylates, perfluoropolyether and other fluorochemical materials, olefin materials, long-chain hydrocarbon-functional materials, and copolymers and mixtures thereof. These release materials could be a continuous coating, pattern coating, or microstructured materials.

In some embodiments, each of the sheets 115, 125, 135 may also be release liners, including, but not limited to, those made with a plastic (e.g., a polyester) film core having a layer of a thermoplastic polymeric material (e.g., polyethylene) laminated to at least the release side of the liner. Release liners with a paper core having a structural support layer of a thermoplastic polymeric material (e.g., polyethylene) forming at least the release side of the liner may also be used.

In an exemplary manufacturing process, the second major surfaces 112, 122, 132 of the respective substrates 113, 123, 133 may be coated partially with the corresponding adhesives 114, 124, 134. The substrates 113, 123, 133 may be then removably secured to the respective sheets 115, 125, 135 to form the respective first, second and third delivery portions 110, 120, 130. The first, second and third delivery portions 110, 120, 130 may be then assembled in a fan-folded configuration with the portions of the adhesives 114, 124, 134 removably secured to the underlying substrates, thereby forming the stack 100. The stack 100 may be disposed in a dispenser for dispensing individual delivery portions of the stack 100 in a pop-up manner.

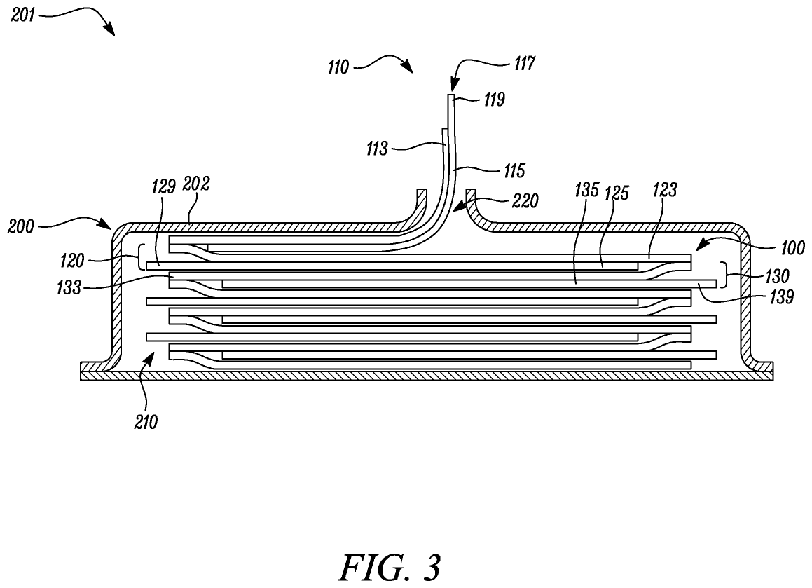

FIG. 3 illustrates a dispensing system 201 including a dispenser 200 and the stack 100 received within the dispenser 200. For the purposes of clarity, only the first, second and third delivery portions 110, 120, 130 are referenced by numerals in FIG. 3. The underlying delivery portions, through shown, are not referenced separately. The dispenser 200 includes a housing 202 defining a cavity 210 and an opening 220. The opening 220 is disposed at a top portion of the housing 202. The housing 202 may be made of a variety of materials including, but not limited to, plastic, paper, glass, metal, or a combination thereof. The opening 220 may be a slot. The stack 100 is received within the cavity 210 of the housing 202. The sheet 115 of the first delivery portion 110 extends at least partly through the opening 220 of the dispenser 200. The substrate 113 of the first delivery portion 110 also extends at least partly through the opening 220. The dispenser 200 may enable pop-up dispensing of the first, second and third delivery portions 110, 120, 130 of the stack 100.

A design of the dispenser 200 can be modified based on various parameters of the stack 100, such as shape, dimensions, material etc. The dispenser 200 can be mounted on a surface or a component. In some cases, the dispenser 200 can be a wearable device that can be carried by a person. The dispenser 200 can be used in various environments in the vicinity of a patient or a clinician. The dispenser 200 can be mounted or positioned in different areas, for example, cabinets, walls, tables, bed rail, attending caregivers, clinicians, and so forth.

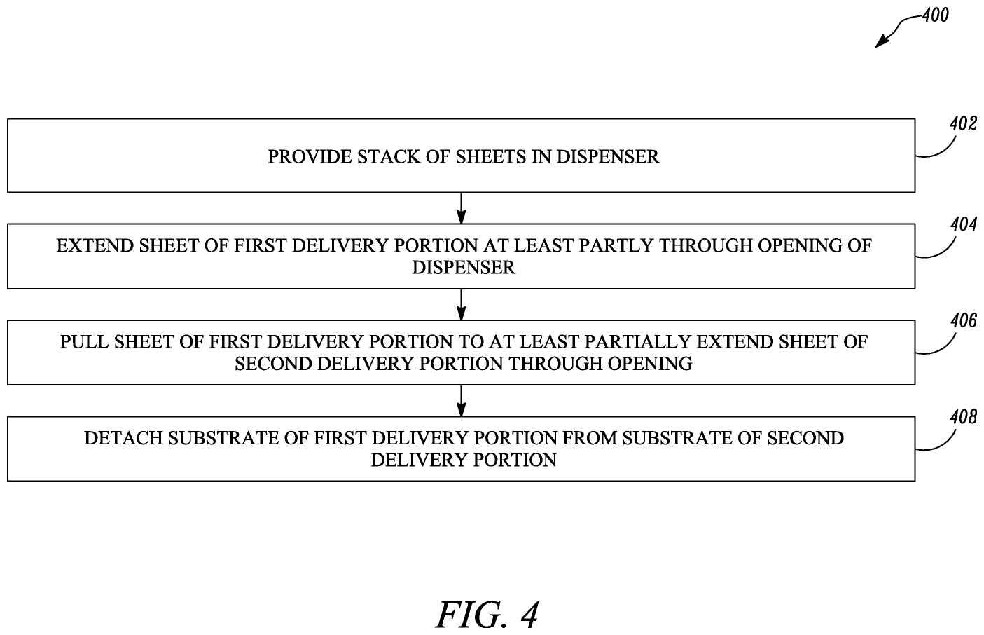

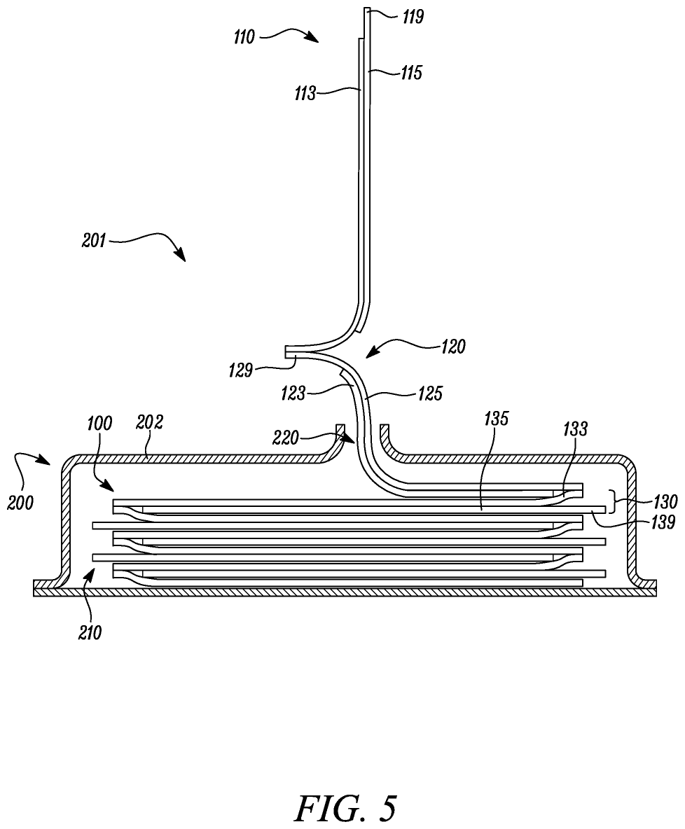

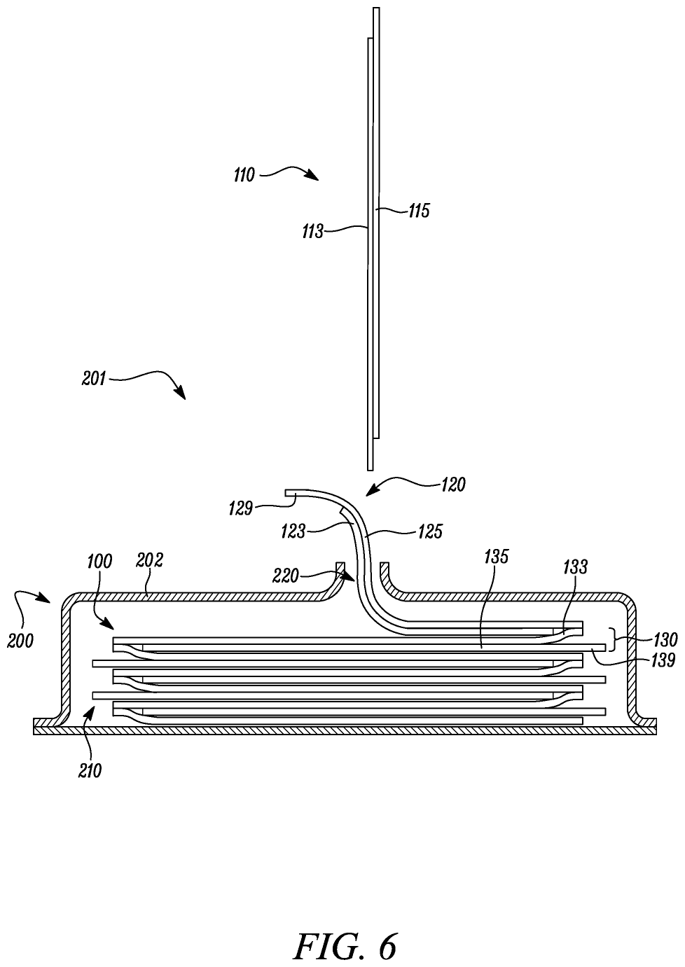

FIG. 4 illustrates a flowchart of a method 400 of dispensing the stack 100 of the dispensing system 201. FIGS. 5 and 6 illustrate dispensing of the first delivery portion 110 from the dispenser 200. Referring to FIGS. 3 to 6, at step 402, the method 400 includes providing the stack 100 in the dispenser 200. The stack 100 is disposed within the cavity 210 of the housing 202.

At step 404, the method 400 includes extending the sheet 115 of the first delivery portion 110 at least partly through the opening 220 of the dispenser 200. The substrate 113 of the first delivery portion 110 may also extend at least partly through the opening 220 along with the sheet 115.

At step 406, the method 400 further includes pulling the sheet 115 of the first delivery portion 110 to at least partially extend the sheet 125 of the second delivery portion 120 through the opening 220. The flag 119 of the sheet 115 may be used to pull the sheet 115 away from the dispenser 200. The flag 119 may enable one-handed pulling of the sheet 115. As shown in FIG. 5, upon pulling the sheet 115, the sheet 125 of the second delivery portion 120 also extends at least partially through the opening 220. This is due to the removable adhesive connection between the substrate 113 of the first delivery portion 110 and the substrate 123 of the second delivery portion 120. The substrate 123 of the second delivery portion 120 may also extend at least partly through the opening 220 along with the sheet 125.

At step 408, the method 400 further includes detaching the substrate of the first delivery portion 110 from the substrate 123 of the second delivery portion 120. As shown in FIG. 6, upon further pulling of the sheet 115 of the first delivery portion 110, the substrate 113 of the first delivery portion 110 detaches from the substrate 123 of the second delivery portion 120 by a peeling action. Due to the Z-folded configuration of the stack 100, the removable adhesive connection between the substrate 123 of the second delivery portion 120 and the substrate 133 of the third delivery portion 130 may remain substantially intact during dispensing of the first delivery portion 110. Upon removal of the first delivery portion 110, the sheet 125 of the second delivery portion 120 extends at least partly through the opening 220 to enable one-handed dispensing.

In general, the uppermost delivery portion of the stack 100 can be removed by pulling the flag of the corresponding sheet. Upon removal of the uppermost delivery portion, the underlying delivery portion pops up and the flag of the corresponding sheet extends through the opening 220 of the dispenser 200. Successive delivery portions can be sequentially dispensed in a similar manner.

The stack 100 and the dispensing system 201 of the present disclosure may enable one-handed dispensing. The stack 100 may further enable compact and flat packaging as opposed to conventional tape rolls. Compact packaging may facilitate shipping and supply. The stack 100 and the dispensing system 201 can easily fit into kits. Further, the dispensing system 201 can be easily placed at a point of use or care. The substrate of each delivery portion can also be used as an instruction sheet. The stack 100 may also allow the delivery portions to be organized efficiently.

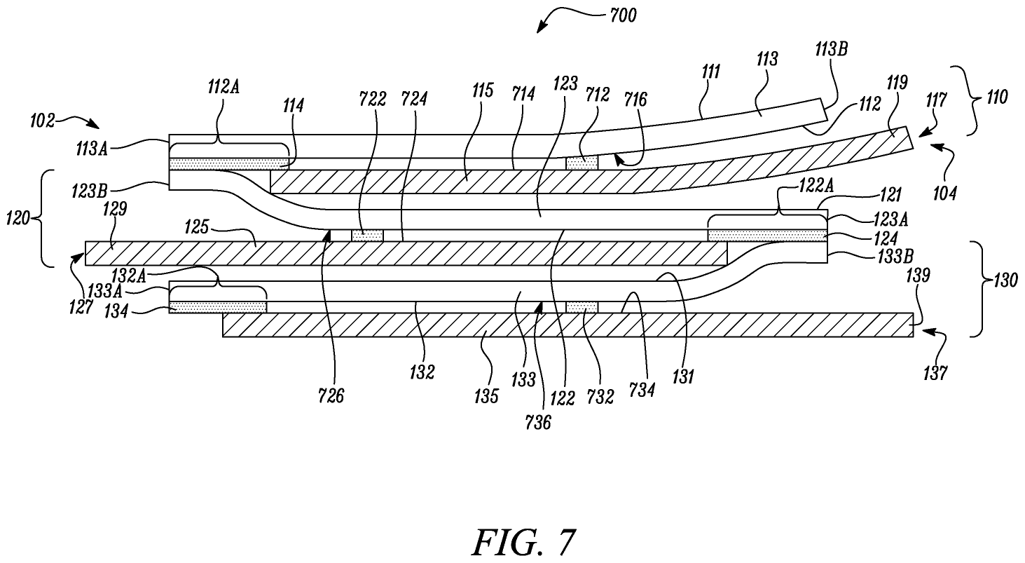

FIG. 7 illustrates a side sectional view of one embodiment of a stack of sheets 700 (hereinafter referred to as “stack 700”). The stack 700 is substantially similar to the stack 100 shown in FIGS. 1 and 2. The stack 700 includes the first delivery portion 110, the second delivery portion 120, and the third delivery portion 130 stacked on top of each other.

However, the sheet 115 of the first delivery portion 110 includes a sheet adhesive 712 on a top surface 714 of the sheet 115. The sheet adhesive 712 releasably secures the sheet 115 to a non-adhesive portion 716 of the second major surface 112 of the substrate 113. The non-adhesive portion 716 of the second major surface 112 is not covered by the adhesive 114. In some embodiments, the sheet adhesive 712 covers less than 15%, less than 10%, less than 5%, or less than 2% of a total area of the top surface 714 of the sheet 115.

Further, the sheet 125 of the second delivery portion 120 includes a sheet adhesive 722 on a top surface 724 of the sheet 125. The sheet adhesive 722 releasably secures the sheet 125 to a non-adhesive portion 726 of the second major surface 122 of the substrate 123. The non-adhesive portion 726 of the second major surface 122 is not covered by the adhesive 124. In some embodiments, the sheet adhesive 722 covers less than 15%, less than 10%, less than 5%, or less than 2% of a total area of the top surface 724 of the sheet 125.

Further, the sheet 135 of the third delivery portion 130 includes a sheet adhesive 732 on a top surface 734 of the sheet 135. The sheet adhesive 732 releasably secures the sheet 135 to a non-adhesive portion 736 of the second major surface 132 of the substrate 133. The non-adhesive portion 736 of the second major surface 132 is not covered by the adhesive 134. In some embodiments, the sheet adhesive 732 covers less than 15%, less than 10%, less than 5%, or less than 2% of a total area of the top surface 734 of the sheet 135.

In some embodiments, the sheet adhesive 712, 722, 732 of each of the sheets 115, 125, 135 is a pressure sensitive adhesive. In some embodiments, the sheet adhesives 712, 722, 732 may be similar to the adhesives 114, 124, 134, respectively. The sheet adhesives 712, 722, 732 may releasably secure the respective sheets 115, 125, 135 to the respective substrates 113, 123, 133 during pop-up dispensing.

Although specific embodiments have been shown and described herein, it is understood that these embodiments are merely illustrative of the many possible specific arrangements that can be devised in application of the principles of the invention. Numerous and varied other arrangements can be devised in accordance with these principles by those of skill in the art without departing from the spirit and scope of the invention. The scope of the present invention should not be limited to the structures described in this application, but only by the structures described by the language of the claims and the equivalents of those structures.

What is claimed is:

1. A stack of sheets with a first end and a second end, opposite the first end, the stack of sheets comprising:
a first delivery portion comprising:
a substrate having a first major surface and a second major surface, opposite the first major surface;
an adhesive disposed on a portion of the second major surface of the substrate of the first delivery portion at the first end of the stack; and
a sheet removably secured to a portion of the adhesive disposed on the substrate of the first delivery portion; and
a second delivery portion comprising:
a substrate having a first major surface and a second major surface, opposite the first major surface;
an adhesive disposed on a portion of the second major surface of the substrate of the second delivery portion at the second end of the stack; and
a sheet removably secured to a portion of the adhesive disposed on the substrate of the second delivery portion;
wherein the adhesive of the first delivery portion removably secures to the first major surface of the substrate of the second delivery portion at the first end of the stack.

2. The stack of sheets according to claim 1, further comprising:
a third delivery portion comprising:
a substrate having a first major surface and a second major surface, opposite the first major surface;
an adhesive disposed on a portion of the second major surface of the substrate of the third delivery portion at the first end of the stack; and
a sheet removably secured to a portion of the adhesive disposed on the substrate of the third delivery portion;
wherein the adhesive of the second delivery portion removably secures to the first major surface of the substrate of the third delivery portion at the second end of the stack.

3. The stack of sheets according to claim 2, wherein the sheet of at least one of the first, second and third delivery portions comprises a free end that is disconnected from the stack and forms a flag.

4. The stack of sheets according to claim 3, wherein the free end of the sheet of the at least one of the first, second and third delivery portions extends beyond an edge of the corresponding substrate.

5. The stack of sheets according to claim 2, wherein the sheet of each of the first, second and third delivery portions is not secured to a first major surface of an underlying substrate.

6. The stack of sheets according to claim 2, wherein the sheet of at least one of the first, second and third delivery portions comprises a sheet adhesive on a top surface of the sheet, and wherein the sheet adhesive releasably secures the sheet to a non-adhesive portion of the second major surface of the corresponding substrate.

7. The stack of sheets according to claim 6, wherein the sheet adhesive is a pressure sensitive adhesive.

8. The stack of sheets according to claim 2, wherein the sheet of each of the first, second and third delivery portions carries at least one object.

9. The stack of sheets according to claim 8, wherein the at least one object is a tape strip.

10. The stack of sheets according to claim 2, wherein the adhesive of each of the first, second and third delivery portions is a pressure sensitive adhesive.

11. A dispenser comprising an opening, the dispenser receiving the stack of sheets according to claim 1, wherein the sheet of the first delivery portion extends at least partly through the opening.

12. A dispensing system comprising:
a dispenser comprising an opening; and
a stack of sheets with a first end and a second end, opposite the first end, the stack of sheets received within the dispenser, the stack of sheets comprising:
a first delivery portion comprising:
a substrate having a first major surface and a second major surface, opposite the first major surface;
an adhesive disposed on a portion of the second major surface of the substrate of the first delivery portion at the first end of the stack; and
a sheet removably secured to a portion of the adhesive disposed on the substrate of the first delivery portion; and
a second delivery portion comprising:
a substrate having a first major surface and a second major surface, opposite the first major surface;
an adhesive disposed on a portion of the second major surface of the substrate of the second delivery portion at the second end of the stack; and
a sheet removably secured to a portion of the adhesive disposed on the substrate of the second delivery portion;
wherein the adhesive of the first delivery portion removably secures to the first major surface of the substrate of the second delivery portion at the first end of the stack, and wherein the sheet of the first delivery portion extends at least partly through the opening of the dispenser.

13. The dispensing system according to claim 12, wherein the stack of sheets further comprises:
a third delivery portion comprising:
a substrate having a first major surface and a second major surface, opposite the first major surface;
an adhesive disposed on a portion of the second major surface of the substrate of the third delivery portion at the first end of the stack; and
a sheet removably secured to a portion of the adhesive disposed on the substrate of the third delivery portion;
wherein the adhesive of the second delivery portion removably secures to the first major surface of the substrate of the third delivery portion at the second end of the stack.

14. The dispensing system according to claim 13, wherein the sheet of at least one of the first, second and third delivery portions comprises a free end that is disconnected from the stack and forms a flag, wherein the free end at least partly extends through the opening of the dispenser for dispensing of the at least one of the first, second and third delivery portions.

15. The dispensing system according to claim 14, wherein the free end of the sheet of the at least one of the first, second and third delivery portions extends beyond an edge of the corresponding substrate.

16. The dispensing system according to claim 13, wherein the sheet of each of the first, second and third delivery portions is not secured to the first major surface of an underlying substrate.

17. The dispensing system according to claim 13, wherein the sheet of at least one of the first, second and third delivery portions comprises a sheet adhesive on a top surface of the sheet, and wherein the sheet adhesive removably secures the sheet to a non-adhesive portion of the second major surface of the corresponding substrate.

18. The dispensing system according to claim 13, wherein the sheet of each of the first, second and third delivery portions carries at least one object.

19. The dispensing system according to claim 18, wherein the at least one object is a tape strip.

20. A method of dispensing the stack of sheets of the dispensing system according to claim 12, the method comprising:
providing the stack of sheets in the dispenser;
extending the sheet of the first delivery portion at least partly through the opening of the dispenser;
pulling the sheet of the first delivery portion to at least partially extend the sheet of the second delivery portion through the opening; and
detaching the substrate of the first delivery portion from the substrate of the second delivery portion.
